(19) United States
(12) Patent Application Publication
(10) Pub. No.: US 2023/0306747 A1
(43) Pub. Date: Sep. 28, 2023

(54) SYSTEM AND METHOD FOR MANAGING TRAFFIC IN ENVIRONMENT

(71) Applicant: Darvis Inc., San Francisco, CA (US)

(72) Inventors: Jan-Philipp Mohr, Hamburg (DE); Brian Earp, Merrimack, NH (US); Rajeev Ratan, Wembley (GB)

(21) Appl. No.: 17/700,953

(22) Filed: Mar. 22, 2022

(51) Int. Cl. G06V 20/54; G06T 7/20; G06V 40/10; H04N 5/272; H04N 5/232; G08G 1/052; G08G 1/04; G05D 1/02

(52) U.S. Cl. CPC G06V 20/54; G06T 7/20; G06V 40/10; H04N 5/272; H04N 5/23203; G08G 1/052; G08G 1/04; G05D 1/0223; G06V 2201/08; G06T 2207/30236; G06T 2207/30241

(57) ABSTRACT

Disclosed is a system and a method for managing traffic in an environment comprising at least one operational vehicle and at least one autonomous vehicle therein. The system comprising an object detection unit configured to detect the at least one operational vehicle in image frames, a processor configured to receive the image frames with information about the detected at least one operational vehicle therein and process the consecutive image frames to estimate at least one of a speed of the detected at least one operational vehicle and a trajectory of the detected at least one operational vehicle; and a control unit in communication with the processor, wherein the control unit is configured to determine at least one of a preferred speed for the at least one autonomous vehicle and a preferred path for the at least one autonomous vehicle based, at least in part, on the estimated at least one of the speed of the detected at least one operational vehicle and the trajectory of the detected at least one operational vehicle.

### TECHNICAL FIELD

The teachings herein relate generally to monitoring systems and methods and more specifically, to a system and a method managing traffic in an environment comprising at least one operational vehicle and at least one autonomous vehicle operating therein.

### BACKGROUND

In recent times, increasing growth in technology has led to rapid development of various services, such as manufacturing services, management services, logistical services, monitoring and security services, telecommunication services, networking services, internet services, localization services and the like. Such services are being increasingly utilized by millions of users worldwide, such as by customers and/or subscribers employing such services. However, despite rapid developments and tremendous progress in recent years towards more accurate object detection; meanwhile, state of-the-art object detectors also become increasingly more expensive.

Generally, existing systems and methods require higher computational requirements and even then, are unable to provide high and acceptable detection accuracy levels. For example, the latest AmoebaNet-based NAS-FPN detector requires 167 million parameters and 3045 billion FLOPs (30× more than RetinaNet) to achieve state-of the-art accuracy. As a result, the large model sizes and expensive computation costs deter their deployment in many real-world applications such as robotics and self-driving cars wherein model size and latency are highly constrained. Given these real-world resource constraints, model efficiency becomes increasingly important for object detection.

Conventionally, there have been many previous works aiming to develop more efficient detector architectures, such as one stage and anchor-free detectors or compress existing models. Although these methods tend to achieve better efficiency, they usually sacrifice the accuracy of classification or detection. Moreover, associated prior art primarily focuses on a specific or a small range of resource requirements, but the variety of real-world applications, from mobile devices to data-centres, often demand different resource constraints.

Therefore, in light of the foregoing discussion, there exists a need to overcome the aforementioned drawbacks associated with the conventional techniques for managing traffic in an environment comprising at least one operational vehicle and at least one autonomous vehicle operating therein.

### SUMMARY

The teachings herein seek to provide a system and a method for managing traffic in an environment comprising at least one operational vehicle and at least one autonomous vehicle operating therein. The teachings herein seek to provide a solution to the existing problem of a general lack of privacy, security during monitoring and a lack of traffic management capabilities in various environments. An aim of the teachings herein is to provide a solution that overcomes at least partially the problems encountered in prior art and provides an improved system and method for managing traffic in an environment comprising at least one operational vehicle and at least one autonomous vehicle operating therein.

The object of the teachings herein is achieved by the solutions provided in the enclosed independent claims. Advantageous implementations of the teachings herein are further defined in the dependent claims.

In one aspect, the teachings herein provide a system for managing traffic in an environment comprising at least one operational vehicle and at least one autonomous vehicle therein, the system comprising:
an object detection unit configured to detect the at least one operational vehicle in image frames;
a processor configured to:
receive the image frames with information about the detected at least one operational vehicle therein; and
process the consecutive image frames to estimate at least one of a speed of the detected at least one operational vehicle and a trajectory of the detected at least one operational vehicle; and
a control unit in communication with the processor, wherein the control unit is configured to determine at least one of a preferred speed for the at least one autonomous vehicle and a preferred path for the at least one autonomous vehicle based, at least in part, on the estimated at least one of the speed of the detected at least one operational vehicle and the trajectory of the detected at least one operational vehicle.

In another aspect, the teachings herein provide a method for managing traffic in an environment comprising at least one operational vehicle and at least one autonomous vehicle operating therein, the method comprising:
implementing an object detection unit to detect the at least one operational vehicle in the image frames;
implementing a processor to process the consecutive image frames to estimate at least one of a speed of the at least one operational vehicle and a trajectory of the detected at least one operational vehicle; and
implementing a control unit in communication with the processor, wherein the control unit is configured to determine at least one of a preferred speed for the at least one autonomous vehicle and a preferred path for the at least one autonomous vehicle based, at least in part, on the estimated at least one of the speed of the detected at least one operational vehicle and the trajectory of the detected at least one operational vehicle.

It has to be noted that all devices, elements, circuitry, units and means described in the teachings herein could be implemented in the software or hardware elements or any kind of combination thereof. All steps which are performed by the various entities described in the teachings herein as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the teachings herein are susceptible to being combined in various combinations without departing from the scope of the teachings herein as defined by the appended claims.

Additional aspects, advantages, features and objects of the teachings herein would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the teachings herein, exemplary constructions of the teachings herein are shown in the drawings. However, the teachings herein are not limited to specific methods and instrumentalities disclosed herein. Moreover, those in the art will understand that the drawings are not to scale. Wherever possible, like elements have been indicated by identical numbers.

Embodiments of the teachings herein will now be described, by way of example only, with reference to the following diagrams wherein:

FIG. 1 illustrates a block diagram of a system for managing traffic in an environment comprising at least one operational vehicle operating therein, in accordance with various embodiments of the teachings herein;

FIG. 2 illustrates a schematic flowchart listing steps involved in a method for managing traffic in an environment comprising at least one operational vehicle operating therein, in accordance with various embodiments of the teachings herein;

FIG. 3 illustrates a schematic flowchart of a method implemented by the system for managing traffic in an environment comprising at least one operational vehicle operating therein, in accordance with various embodiments of the teachings herein;

FIGS. 4A-4C illustrate exemplary implementations of exemplary user interfaces configured for displaying the anonymized image frames, in accordance with various embodiments of the teachings herein; and

FIG. 5 illustrates a graphical illustration depicting performances of various object detection models implemented by the object detection unit, in accordance with various embodiments of the teachings herein.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the teachings herein and ways in which they can be implemented. Although some modes of carrying out the teachings herein have been disclosed, those skilled in the art would recognize that other embodiments for carrying out or practicing the teachings herein are also possible.

In one aspect, the teachings herein provide a system for managing traffic in an environment comprising at least one operational vehicle and at least one autonomous vehicle therein, the system comprising:
an object detection unit configured to detect the at least one operational vehicle in image frames;
a processor configured to:
receive the image frames with information about the detected at least one operational vehicle therein; and
process the consecutive image frames to estimate at least one of a speed of the detected at least one operational vehicle and a trajectory of the detected at least one operational vehicle; and
a control unit in communication with the processor, wherein the control unit is configured to determine at least one of a preferred speed for the at least one autonomous vehicle and a preferred path for the at least one autonomous vehicle based, at least in part, on the estimated at least one of the speed of the detected at least one operational vehicle and the trajectory of the detected at least one operational vehicle.

In another aspect, the teachings herein provide a method for managing traffic in an environment comprising at least one operational vehicle and at least one autonomous vehicle operating therein, the method comprising:
implementing an object detection unit to detect the at least one operational vehicle in the image frames;
implementing a processor to process the consecutive image frames to estimate at least one of a speed of the at least one operational vehicle and a trajectory of the detected at least one operational vehicle; and
implementing a control unit in communication with the processor, wherein the control unit is configured to determine at least one of a preferred speed for the at least one autonomous vehicle and a preferred path for the at least one autonomous vehicle based, at least in part, on the estimated at least one of the speed of the detected at least one operational vehicle and the trajectory of the detected at least one operational vehicle.

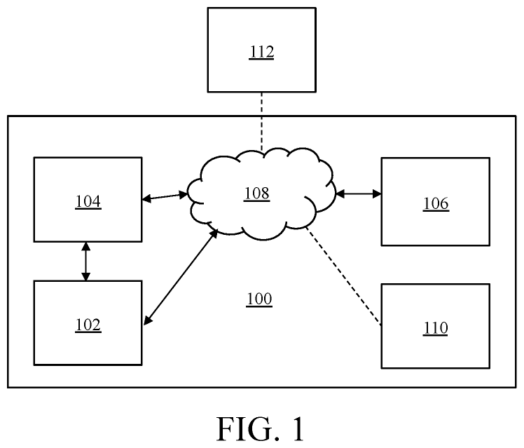

Referring to FIG. 1, illustrated is a block diagram of a system for managing traffic in an environment comprising at least one operational vehicle and at least one autonomous vehicle therein, in accordance with the teachings herein. As shown, the system 100 comprises an object detection unit 104 configured to detect the at least one operational vehicle and the at least one autonomous vehicle in the image frames for further processing thereof. The term “at least one operational vehicle” refers to a type of vehicle operating in the environment and operable to perform specified function(s). For example, the operational vehicle may be at least one of a motor vehicle, an industrial vehicle, a carrier or trolley, and the like. The term “autonomous vehicle” as used herein refers to a vehicle capable of sensing the environment (or surroundings) and operating without any human involvement i.e., without the need of a human passenger for assuming control. For example, the autonomous vehicles may be an autonomous guided vehicle (AGV). It will be appreciated that any type of autonomous vehicle (i.e., partially autonomous, conditionally autonomous, fully autonomous or driver-assisted vehicles) may be operating within the environment whose traffic may thereby be managed by the system 100 or the method 200 without limiting from the scope of the teachings herein. The system 100 further comprises a processor 106 configured to receive and thereby process the consecutive image frames to determine at least one of the speed and trajectory of the detected at least one operational vehicle in the environment. The system 100 further comprises a control unit 110 in communication with the processor 106, wherein the control unit 110 is configured to determine at least one of a preferred speed for the at least one autonomous vehicle and a preferred path for the at least one autonomous vehicle based, at least in part, on the estimated at least one of the speed of the detected at least one operational vehicle and the trajectory of the detected at least one operational vehicle.

In one or more embodiments, the system 100 further comprises one or more imaging devices 102 configured to capture the image frames of the environment. Typically, the system 100 comprises one or more imaging devices 102 configured to capture image frames of the environment that are received by the processor 106 for further processing thereof. Herein, the one or more imaging devices 102 are configured to capture a plurality of image frames (or a video) of the environment, wherein the environment comprises at least one of the at least one operational vehicle and at least one autonomous vehicle, one or more person(s). In an exemplary scenario, the environment relates to a manufacturing plant comprising multiple at least one operational vehicle The term “imaging device” as user herein refers to a device configured to capture images frames (or video) of the environment. For example, the imaging device 102 may be a digital camera, a closed-circuit television (CCTV) camera, a dome camera, a bullet camera, a box camera, a Pan, Tilt and Zoom (PTZ) camera, and the like. In an exemplary scenario, the one or more imaging device may be a BOSCH® Inteox 7000i camera. Beneficially, the one or more imaging devices 102 are configured to provide high quality and/or resolution images of the environment to enable the system 100 and/or the method 200 to differentiate and classify or detect the at least one operational vehicle to manage the traffic in the environment (for example, in a congested scene) with a high accuracy and/or precision. Additionally, the one or more imaging devices 102 are complimented by one or more machine learning models based on deep neural networks (DNN) configured to provide higher quality images with lower number of disturbances such as, but not limited to, vehicular headlights, shadows and/or glares from the image frames to improve mobility, safety and efficacy of the system 100 and/or method 200.

In one or more embodiments, the one or more imaging devices 102 implement a customized operating system. The method 200 further comprises implementing a customized operating system in the one or more imaging devices 102. Herein, the customized operating system is implemented in the one or more imaging devices, wherein the one or more imaging devices 102 implement the customized operating system for employing one or more applications provided by the operating system. The “customized operating system” as used herein may refer to a proprietary operating system that may comprise a software platform further comprising a plurality of applications operable to be run on or via the one or more imaging devices 102, in which the customized operating system is implemented, to additionally perform one or more pre-customized operations thereat. For example, the customized operating system may employ one or more applications for performing the one or more pre-customized operations individually or simultaneously including, but not limited to, entity detection, user detection, threat detection, object or image anonymizing, flow optimization and analysis, heat mapping, and the like. In an example, the customized operating system is Azena® operating system, wherein the one or more imaging devices 102 may employ one or more of the applications provided by the customized operating system or platform. Beneficially, the customized operating system is a low-resource operating system that may be run on hardware having lower processing capabilities such as, the one or more imaging 102. Moreover, it enables the system 100, the method 200, and/or the one or more imaging devices 102 to perform a myriad of operations simultaneously and thus improving the efficiency and efficacy of the system 100 or the method 200.

Moreover, optionally, the system 100 further comprises a communication interface 108 configured to enable communication between the object detection unit 104 and the processor 106. The communication interface 108 includes a medium (e.g., a communication channel) through which the system 100 components communicate with each other. The term “communication interface” refers to an arrangement of interconnected programmable and/or non-programmable components that are configured to facilitate data communication between the elements of the system 100, whether available or known at the time of filing or as later developed. Furthermore, the communication interface 108 may include, but is not limited to, one or more peer-to-peer network, a hybrid peer-to-peer network, local area networks (LANs), radio access networks (RANs), metropolitan area networks (MANS), wide area networks (WANs), all or a portion of a public network such as the global computer network known as the Internet, a private network, a cellular network and any other communication system or systems at one or more locations. Additionally, the communication interface 108 comprises wired or wireless communication that can be carried out via any number of known protocols, including, but not limited to, Internet Protocol (IP), Wireless Access Protocol (WAP), Frame Relay, or Asynchronous Transfer Mode (ATM). Moreover, any other suitable protocols using voice, video, data, or combinations thereof, can also be employed. Moreover, although the system 100 is frequently described herein as being implemented with TCP/IP communications protocols, the system 100 may also be implemented using IPX, AppleTalk®, IP-6, NetBIOS, OSI, any tunnelling protocol (e.g., IPsec, SSH), or any number of existing or future protocols.

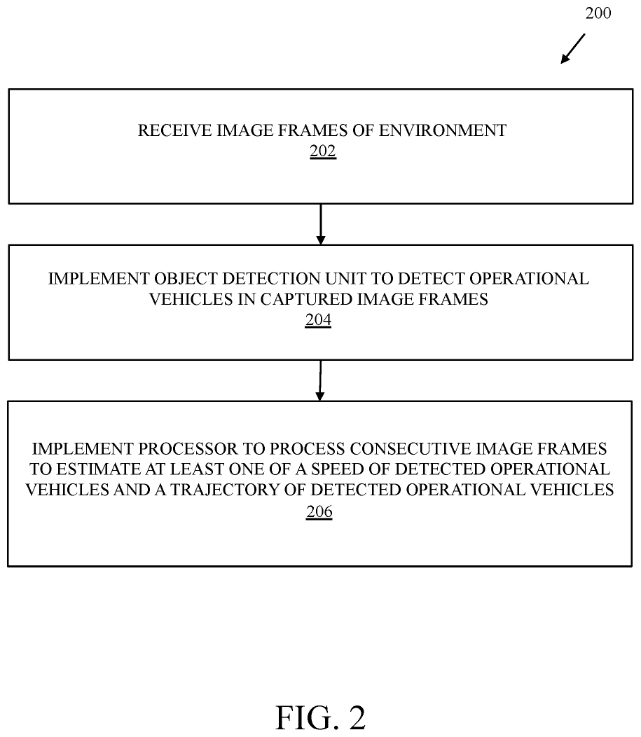

Referring to FIG. 2, illustrated is a flowchart listing steps involved in a method for managing traffic in an environment comprising at least one operational vehicle operating therein, in accordance with the teachings herein. As shown, the method 200 comprises steps 202, 204 and 206, which have been described in detail in the proceeding paragraphs.

Referring to FIGS. 1 and 2 in combination, the system 100 comprises an object detection unit 104 configured to detect the at least one operational vehicle in the image frames. At a step 202, the method 200 further comprises implementing an object detection unit 104 to detect the at least one operational vehicle in the image frames. Herein, the object detection unit 104 may be operatively coupled with the one or more imaging devices 102 and configured to employ computer vision to detect and/or track one or more objects such as, personnel or the persons, at least one operational vehicle, at least one autonomous vehicle, markings or signs, barriers in the environment. The “object detection unit” refers to an architecture comprising software and hardware components configured to enable detection and/or tracking of the at least one operational vehicle and/or the at least one autonomous vehicle in the environment. For example, the object detection unit 104 may comprise a memory having computer program code stored therein, a processor, a network interface for performing the task of object detection. Typically, the object detection unit 104 uses object detection algorithms such as, deep learning-based object detection algorithms for finding and localizing the objects in real-time to support autonomous driving and traffic management in the environment in order to ensure a safe and robust driving performance via the system 100 and/or the method 200.

In one or more embodiments, the object detection unit 104 executes an EfficentDet-lite model. The method 200 further comprises executing an EfficentDet-lite model for the object detection unit 104. The “EfficentDet-lite model” refers to a type of object detection machine learning model configured to perform a plurality of optimizations and/or operations for detecting the objects in the environment, such as the use of a weighted Bi-directional Feature Pyramid Network (BiFPN) for allowing easier and faster multi-scale feature combinations, and/or a compound scaling method for uniformly scaling the resolution, depth and width for all feature networks and box/class prediction networks at the same time. It will be appreciated that the object detection unit 104 may employ other objection detection models such as, YOLO (you only look once) models, RetinaNet models, AmoebaNet models, Mask region-based convolutional neural networks (R-CNN) and the like. However, the EfficientDet-lite model is implemented by the object detecting unit 104 owing to lower computational requirements (i.e., faster inference) and higher (or acceptable) accuracy levels in comparison to other object detection models.

In one or more embodiments the object detection unit 104 is further configured to detect one or more persons in the image frames and anonymize the detected persons in the image frames, to generate the anonymized image frames. Herein, the method 200 further comprises anonymizing, by the object detection unit 104, the detected operational the detected one or more persons in the image frames such as, personnel working in the environment, to generate anonymized image frames. In some implementations, the system 100 or method 200 may be required to anonymize the image frames to ensure privacy and security of the one or more persons present in the environment. Such an anonymizing operation by the object detection unit 104 may be configured to beneficially remove any unwanted details of the operation to ensure maintenance of privacy of the one or more persons operating or present in the environment.

In one or more embodiments, the system 100 further comprises a user interface 112 configured to display the anonymized image frames. The method 200 further comprises providing a user interface 112 configured to display the anonymized image frames. The term “user interface” (UI) refers to a medium of user interaction with the system 100 or generally to any computer, website, or application and configured to display the anonymized image frames. Beneficially, the user interface 112 is operable to make the user experience smooth and intuitive, requiring minimum effort to receive the desired outcome, preferably in the shortest period of time. The user interface 112 may be at least one of a Graphical User Interfaces (GUI), Command Line Interfaces (CLI), Form-based interfaces, Menu-based interfaces, Natural language interfaces. Herein, the user interface 112 may be in the form of a website or an application. The user-interface 112 represents a way through which a user i.e., the person in need of the system 100 for managing traffic in an environment comprising at least one operational vehicle operating therein, may operate therewith.

In one or more embodiments, the user interface 112 is further configured to overlay information about the estimated at least one of the speed of the at least one operational vehicle and the trajectory of the at least one operational vehicle on the respective at least one operational vehicle in the displayed anonymized image frames. The method 200 further comprises overlaying, by the user interface 112, information about the estimated at least one of the speed of the at least one operational vehicle and the trajectory of the at least one operational vehicle on the respective at least one operational vehicle in the displayed anonymized image frames. Herein, the user interface 112 is configured to display the estimates of at least one of the speed of the at least one operational vehicle and the trajectory of the at least one operational vehicle in the displayed anonymized frames. Moreover, the user interface 112 may also display the direction of movement of the at least one operational vehicle, vehicular classification, probability of classification, and the like. The user interface 112 may display bounding boxes associated with each of the objects detected in the environment, wherein the bounding box comprises the information associated with the detected at least one operational vehicle and is thereby overlayed over by the user interface 112 for quicker reference.

Referring to FIGS. 1 and 2 in combination, the processor 106 is configured to receive the image frames with information about the detected at least one operational vehicle therein and process the consecutive image frames to estimate at least one of a speed of the at least one operational vehicle and a trajectory of the detected at least one operational vehicle. Typically, at a step 204, the method 200 further comprises implementing a processor 106 to process the consecutive image frames to estimate at least one of a speed of the at least one operational vehicle and a trajectory of the detected at least one operational vehicle. Typically, the processor 106 is configured to receive and thereby process the consecutive images frames for further determining and/or estimating at least one of the speed and the trajectory of the detected at least one operational vehicle in the environment. Herein, the processor 106 may determine the distance travelled by a given operational vehicle between any two consecutive image frames using the image frames and based on the time taken between capturing the consecutive image frames, the processor 106 may thereby determine the speed of the operational vehicle and consequently the trajectory of the operational vehicle.

The term “processor” as used herein refers to a structure and/or module that includes programmable and/or non-programmable components configured to store, process and/or share information and/or signals for managing traffic in an environment comprising at least one operational vehicle operating therein. The processor 106 may be having elements, such as a display, control buttons or joysticks, processor, memory and the like. Typically, the processor 106 is operable to perform one or more operations for managing traffic in an environment comprising at least one operational vehicle operating therein. In the present examples, the processor 106 may include components such as memory, a controller, a network adapter and the like, to store, process and/or share information with other computing components, such as a user device, a remote server unit, a database. Optionally, the processor 106 includes any arrangement of physical or virtual computational entities capable of enhancing information to perform various computational tasks. Optionally, the processor 106 is supplemented with additional computation systems, such as neural networks, and hierarchical clusters of pseudo-analog variable state machines implementing artificial intelligence algorithms. Moreover, the processor 106 refers to a computational element that is operable to respond to and processes instructions for managing traffic in an environment comprising at least one operational vehicle operating therein. Optionally, the processor 106 includes, but is not limited to, a microcontroller, a micro-controller, a complex instruction set computing (CISC) microcontroller, a reduced instruction set (RISC) microcontroller, a very long instruction word (VLIW) microcontroller, Field Programmable Gate Array (FPGA) or any other type of processing circuit, for example as aforementioned. Beneficially, the determination and/or estimation of the speed and trajectory of the detected at least one operational vehicle enables the system 100 and the method 200 to effectively manage the traffic in the environment by effectively guiding the autonomous vehicles therein to ensure a safe and query-free operation.

In one or more embodiments, the processor 106 is a graphical processor. The term “graphical processor” as user herein relates to a type of a specialized processor designed to accelerate graphics rendering in the user interface 112. Beneficially, the graphical processor may be additionally provided such that the system 100 or the method 200 may process multiple pieces of data simultaneously, making them useful for machine learning, video editing, and various applications in an effective and efficient manner. Conventionally, existing systems and methods are unable to classify the objects at larger distances with an acceptable accuracy and thus, the system 100 and/or method 200 is provided with a dedicated graphical processor 106 for better graphical rendering and thereby precise object classifications. Notably, the dedicated graphical processor 106 improves the accuracy of the object detection model employed by the object detection unit 104 for improved model accuracy and higher frame rate (FPS) such that the system 100 and/or method 200 may further provide improved object detection at larger distances, improved speed and trajectory estimations, historical heat map generation, accurate distance estimations between the at least one operational vehicle and the detected one or more persons, improved route optimizations and so forth without limiting from the scope of the teachings herein.

In one or more embodiments, the processor 106 is integrated in each of the one or more imaging devices 102, to process the corresponding consecutive image frames. The method 200 further comprises integrating the processor 106 in each of the one or more imaging devices 102, to process the corresponding consecutive image frames. Herein, the processor 106 is integrated in each of the one or more imaging devices 102 such that each of the one or more imaging devices 102 may be configured to operate independently, to perform the object detection operations and to enable traffic management of the at least one operational vehicle without a need of any external device or equipment. Beneficially, such an integration reduces the size of the required setup and the time taken by the system 100 or method 200 for managing traffic in the environment comprising at least one operational vehicle operating therein.

In one or more embodiments, the object detection unit 104 is implemented in the processor 106, to detect the at least one operational vehicle in the corresponding image frames. The method 200 further comprises implementing the object detection unit 104 in each of the one or more imaging devices 102, to detect the at least one operational vehicle in the corresponding image frames. Herein, the object detection unit 104 is implemented in the processor 106 that may be integrated into the one or more imaging devices 102. Beneficially, such an implementation of the combination of the one or more imaging devices 102, the object detection unit 104, and the processor in a single unit significantly reduces the size occupied by the system and at the same time provide a single setup and solution for managing traffic in the environment comprising at least one operational vehicle operating therein.

Referring to FIGS. 1 and 2 in combination, the system 100 further comprises a control unit 110 in communication with the processor 106 to receive information about the estimated at least one of the speed of the at least one operational vehicle and the trajectory of the at least one operational vehicle operating in the environment, wherein the control unit 110 is configured to determine at least one of a preferred speed for the at least one autonomous vehicle and a preferred path for the at least one autonomous vehicle based, at least in part, on the received information about the estimated at least one of the speed of the at least one operational vehicle and the trajectory of the at least one operational vehicle. Typically, at a step 206, the method further comprises implementing a control unit 110 in communication with the processor 106, wherein the control unit 110 is configured to determine at least one of a preferred speed for the at least one autonomous vehicle and a preferred path for the at least one autonomous vehicle based, at least in part, on the estimated at least one of the speed of the detected at least one operational vehicle and the trajectory of the detected at least one operational vehicle. Herein, the control unit 110 in communication with the processor 106 is configured to receive information about the estimated at least one of the speed of the at least one operational vehicle and the trajectory of the at least one operational vehicle operating in the environment. Moreover, the method 200 further comprises determining, by the control unit 110, at least one of a preferred speed for the at least one autonomous vehicle and a preferred path for the at least one autonomous vehicle based, at least in part, on the received information about the estimated at least one of the speed of the at least one operational vehicle and the trajectory of the at least one operational vehicle. Herein, the control unit 110 is configured to receive the information relating to the estimated speed and trajectory of the at least one operational vehicle operating in the environment and based on which the control unit 110 is configured to determine at least the preferred speed and optical path for the at least one autonomous vehicle by sensing the surrounding environment (i.e., the detected one or more persons, the at least one operational vehicle, barrier, etc.) associated with a given autonomous vehicle such that the traffic may be effectively managed and any potential accidents and/or faults may be prevented during operation.

The term “control unit” as used herein refers to a structure and/or module that includes programmable and/or non-programmable components configured to store, process and/or share information and/or signals for managing traffic in the environment comprising at least one operational vehicle operating therein. The control unit 110 may be having elements, such as a display, control buttons or joysticks, processor, memory and the like. Typically, the control unit 110 is operable to perform one or more operations for managing traffic in the environment comprising at least one operational vehicle operating therein. In the present examples, the control unit 110 may include components such as memory, a controller, a network adapter and the like, to store, process and/or share information with other computing components, such as a user device, a remote server unit, a database. Optionally, the control unit 110 includes any arrangement of physical or virtual computational entities capable of enhancing information to perform various computational tasks. Optionally, the control unit 110 is supplemented with additional computation systems, such as neural networks, and hierarchical clusters of pseudo-analog variable state machines implementing artificial intelligence algorithms. In an example, the control unit 110 may include components such as a memory, a communication interface, a network adapter and the like, to store, process and/or share information with other computing devices, such as the processor 106, the object detection unit 104, the one or more imaging devices 102. Optionally, the control unit 110 is implemented as a computer program that provides various services (such as database service) to other devices, modules or apparatus. Moreover, the control unit 110 refers to a computational element that is operable to respond to and processes instructions for managing traffic in the environment comprising at least one operational vehicle operating therein. Optionally, the control unit 110 includes, but is not limited to, a microcontroller, a micro-controller, a complex instruction set computing (CISC) microcontroller, a reduced instruction set (RISC) microcontroller, a very long instruction word (VLIW) microcontroller, Field Programmable Gate Array (FPGA) or any other type of processing circuit, for example as aforementioned. Beneficially, the control unit 110 enables the system 100 and/or the method 200 to effectively manage the traffic in the environment to ensure a safe and robust performance thereat.

In one or more embodiments, the control unit 110 is external to the one or more imaging devices 102. In one or more embodiments, the control unit 110 establishes connection with the processor 106 via an MQTT Broker over a TCP connection. The method 200 further comprises implementing the control unit 110 external to the one or more imaging devices 102 and establishing connection between the control unit 110 and the processor 106 via an MQTT Broker over a TCP connection. In some embodiments, the control unit 110 is implemented external to the one or more imaging devices 102 such as, a remote unit to provide additional processing and computational abilities, and at the same time to reduce the size of the overall system 100. Typically, such an external connection of the control unit 110 with the one or more imaging device 102 establishes the connection with the processor 106 via the Message Queue Telemetry Transport (MQTT) broker over the TCP connection. The connection may be established via the MQTT Broker over the TCP connection, wherein data packets may be transmitted at a rate of 5 to 6 times person second and wherein the delays and/or lags are kept minimal (for example, less than 2 seconds), to improve the efficiency and efficacy of the system 100 and/or the method 200. Beneficially, the TCP connection ensures that data is received in-order and acknowledged in an efficient manner, and whereas the MQTT application-level protocol ensures that all data communication between the system elements is encrypted, secure and thereby prevents any unwanted or unauthorized access of the shared data.

In one or more embodiments, the control unit 110 is integrated with the processor 106. Beneficially, such an integration reduces the physical footprint of the system and makes the system 100 simpler.

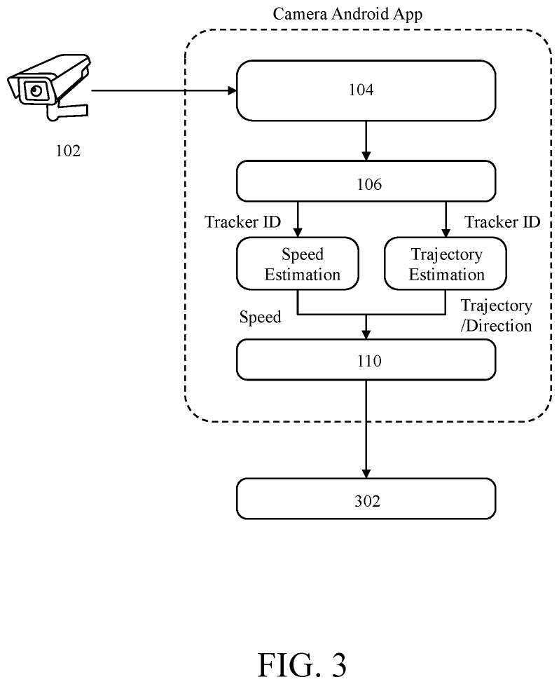

Referring to FIG. 3, illustrated is a schematic flow diagram of the system 100 implementing the method 200 for managing traffic in an environment comprising at least one operational vehicle 302A and at least one autonomous vehicle 302B therein, in accordance with various embodiments of the teachings herein. As shown, the system 100 comprises the one or more imaging devices 102 configured for capturing image frames of the environment. Further, the system 100 comprises the object detection unit 104 that may be operatively coupled with the one or more imaging devices 102 to utilize the image frames to detect the at least one operational vehicle 302A and/or the at least one autonomous vehicle 302B in the image frames of the environment. Optionally, the object detection unit 104 is configured to identify one or more persons in image frames of the environment. Furthermore, the system 100 further comprises the processor 106 configured to receive the image frames, from the one or more imaging devices 102, with information about the detected at least one operational vehicle 302A therein and process the consecutive image frames to estimate at least one of a speed of the at least one operational vehicle 302A and a trajectory of the detected at least one operational vehicle 302A. The system 100 further comprises the control unit 110 in communication with the processor 106 to receive information about the estimated at least one of the speed of the at least one operational vehicle 302A and the trajectory of the at least one operational vehicle 302A operating in the environment, wherein the control unit 110 is configured to determine at least one of a preferred speed for the at least one autonomous vehicle 302B and a preferred path for the at least one autonomous vehicle 302B based, at least in part, on the received information about the estimated at least one of the speed of the at least one operational vehicle 302A and the trajectory of the at least one operational vehicle 302A. Typically, the determined preferred speed and preferred path for the at least one autonomous vehicle 302B is based on the estimated speed and trajectory of the at least one operational vehicle 302A in the environment and is thereby transmitted to the at least one autonomous vehicle 302B (or any associated external system) for allowing convenient traffic flow in the environment.

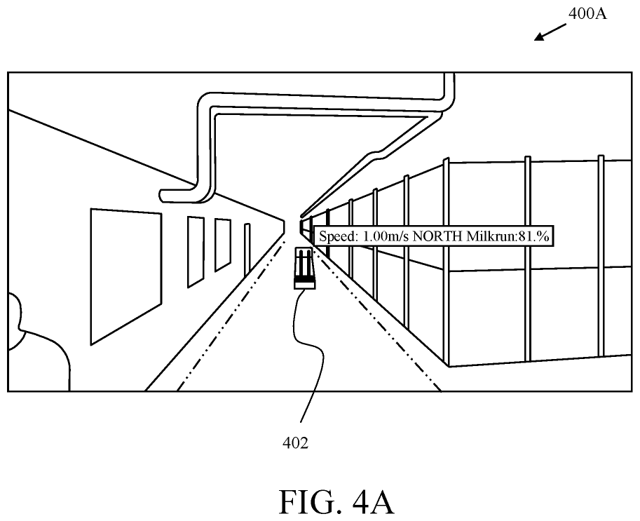

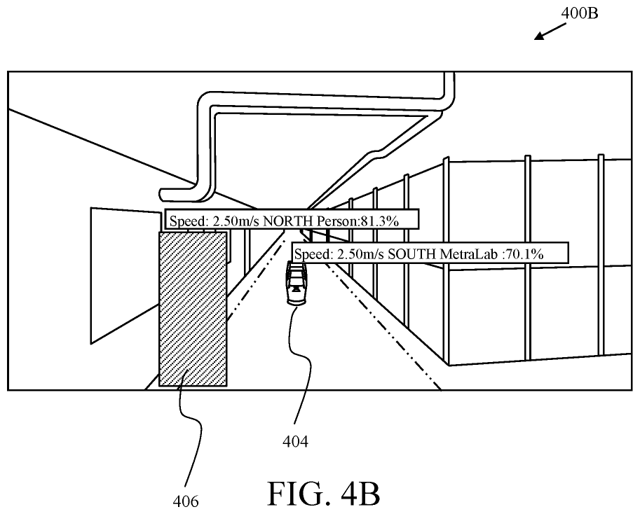

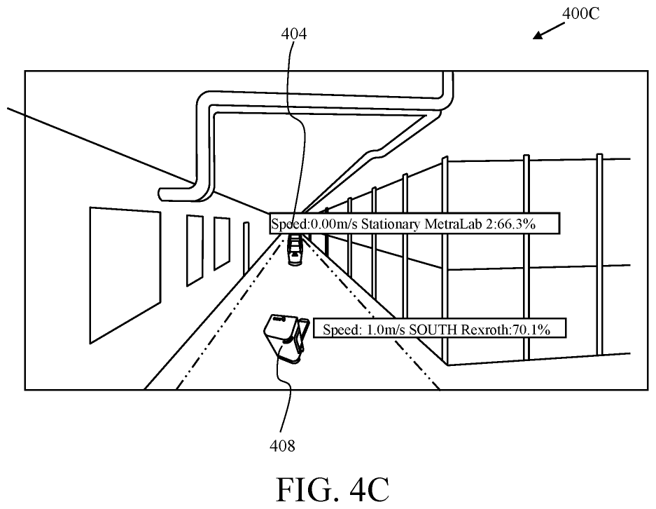

Referring to FIGS. 4A to 4C in combination, illustrated are exemplary user interfaces 112 configured to display the anonymized images frames of the environment, in accordance with various embodiments of the present disclosure.

Referring to FIG. 4A, illustrated is an exemplary first user interface 400A for displaying the image frames of the environment, in accordance with an embodiment of the teachings herein. As shown, the first user interface 400A depicts a first operational vehicle 402 (such as, the at least one operational vehicle 302A), which in the present example is a milk-run carrier or a forklift operable to carry and/or transfer objects from one place to another. Further shown, the speed of the detected first operational vehicle 402 i.e., 1 metre per second and the trajectory (or direction) i.e., north is depicted in an associated bounding box via the first user interface 400A.

Referring to FIG. 4B, illustrated is an exemplary second user interface 400B configured to display the anonymized image frames of the environment, in accordance with another embodiment of the teachings herein. As shown, the second user interface 400B depicts a first autonomous vehicle 404 (such as, the at least one autonomous vehicle 302B), in which the first autonomous vehicle 404 is an automatic guided vehicle (for example, Metralab® AGV). Further shown, the speed of the detected first autonomous vehicle 404 i.e., 2.50 metres per second, the trajectory (or direction) i.e., south, and the probability of classification (or detection) as 70.1% is depicted in an associated bounding box via the second user interface 400B. Moreover, the second user interface 400B further displays an anonymized (i.e., redacted or omitted) bounding box 406 associated with a detected person to protect the privacy and safety of the detected person, wherein the anonymized bounding box 406 is overlayed with at least the speed of the person i.e., 2.5 m/s, the trajectory of the person i.e., north and the probability of classification of the person i.e., 81.3%. Typically, the object detection unit 104 may be configured to detect one or more persons from the captured image frames and thereby anonymize the detected one or more persons thereat.

Referring to FIG. 4C, illustrated is an exemplary third user interface 400C, in accordance with yet another embodiment of the teachings herein. As shown, the third user interface 400C depicts the first autonomous vehicle 404, a second autonomous vehicle 408, in which the second autonomous vehicle 408 is another autonomous guided vehicle (for example, Rexroth® AGV). Further shown, the speed of the detected first autonomous vehicle 404 i.e., 0 metre per second, the trajectory (or state) i.e., stationary, and the probability of classification (or detection) as 66.3% is depicted in an associated bounding box via the third user interface 400C. Similarly, for the second autonomous vehicle 408, the preferred speed of the detected second autonomous vehicle 408 i.e., 1.0 metre per second, the preferred trajectory (or path) i.e., south, and the probability of classification (or detection) as 70.1% is depicted in an associated bounding box via the third user interface 400C.

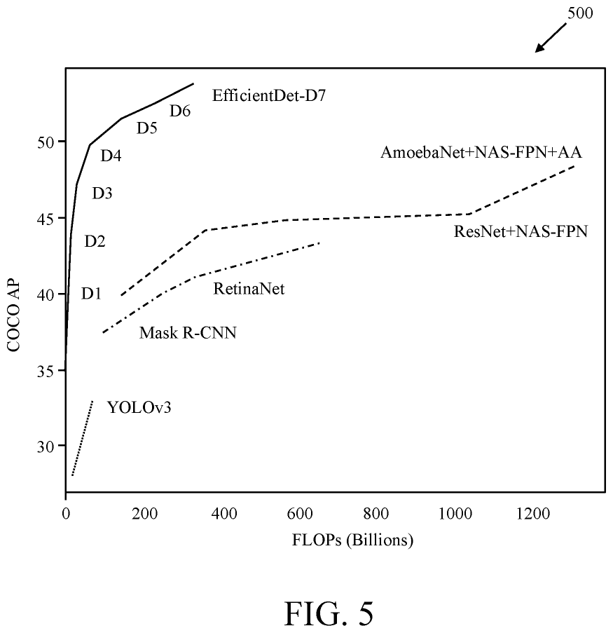

Referring to FIG. 5, illustrated is a graphical representation 500 depicting the performances of various object detection models implemented by the object detection unit 104, in accordance with various embodiments of the teachings herein. Typically, the object detection unit 104 employs a weighted bi-directional feature pyramid network (BiFPN), which allows easy and fast multi-scale feature fusion and a compound scaling method that uniformly scales the resolution, depth, and width for all backbone, feature network, and box/class prediction networks at the same time. Based on these optimizations and better backbones, the EfficientDet model implemented by the object detection unit 104, which consistently achieves much better efficiency than prior art across a wide spectrum of resource constraints. In particular, with single-model and single-scale models, the EfficientDet-D7 achieves state of-the art 55.1 AP on COCO test-development with 77 million parameters and 410 billion FLOPs, being 4— 9 times smaller and using 13— 42 times fewer FLOPs than previous detectors and thus significantly improves the accuracy, efficacy and efficiency of the system 100 and/or the method 200.

Modifications to embodiments of the teachings herein described in the foregoing are possible without departing from the scope of the teachings herein as defined by the accompanying claims. Expressions such as “including”, “comprising”, “incorporating”, “have”, “is” used to describe and claim the teachings herein are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the teachings herein, which are, for clarity, described in the context of separate embodiments, may also be provided in combination in a single embodiment. Conversely, various features of the teachings herein, which are, for brevity, described in the context of a single embodiment, may also be provided separately or in any suitable combination or as suitable in any other described embodiment of the teachings herein.

1.-20. (canceled)

21. A system for managing traffic in an environment comprising at least one operational vehicle and at least one autonomous vehicle therein, the system comprising:
an object detection unit configured to detect the at least one operational vehicle in image frames;
a processor configured to:
receive the image frames with information about the detected at least one operational vehicle therein; and
process the consecutive image frames to estimate at least one of a speed of the detected at least one operational vehicle and a trajectory of the detected at least one operational vehicle; and
a control unit in communication with the processor, wherein the control unit is configured to determine at least one of a preferred speed for the at least one autonomous vehicle and a preferred path for the at least one autonomous vehicle based, at least in part, on the estimated at least one of the speed of the detected at least one operational vehicle and the trajectory of the detected at least one operational vehicle.

22. A system according to claim 21, further comprising one or more imaging devices configured to capture the image frames of the environment.

23. A system according to claim 22, wherein the processor is integrated in each of the one or more imaging devices, to process the corresponding consecutive image frames.

24. A system according to claim 22, wherein the one or more imaging devices implement a customized operating system.

25. A system according to claim 22, wherein the control unit is external to the one or more imaging devices.

26. A system according to claim 21, wherein the control unit establishes connection with the processor via an MQTT Broker over a TCP connection.

27. A system according to claim 21, wherein the processor is a graphical processor.

28. A system according to claim 21, wherein the object detection unit is implemented in the processor, to detect the at least one operational vehicle in the corresponding image frames.

29. A system according to claim 21, wherein the object detection unit executes an EfficentDet-lite model.

30. A system according to claim 21, wherein the object detection unit is further configured to:
detect one or more persons in the image frames; and
anonymize the detected one or more persons in the image frames, to generate anonymized image frames.

31. A system according to claim 30 further comprising a user interface configured to display the anonymized image frames.

32. A system according to claim 31, wherein the user interface is further configured to overlay information about the estimated at least one of the speed of the at least one operational vehicle and the trajectory of the at least one operational vehicle on the respective at least one operational vehicle in the displayed image frames.

33. A method for managing traffic in an environment comprising at least one operational vehicle and at least one autonomous vehicle therein the method comprising:
implementing an object detection unit to detect the at least one operational vehicle in image frames;
implementing a processor to process the consecutive image frames to estimate at least one of a speed of the at least one operational vehicle and a trajectory of the detected at least one operational vehicle; and
implementing a control unit in communication with the processor, wherein the control unit is configured to determine at least one of a preferred speed for the at least one autonomous vehicle and a preferred path for the at least one autonomous vehicle based, at least in part, on the estimated at least one of the speed of the detected at least one operational vehicle and the trajectory of the detected at least one operational vehicle.

34. A method according to claim 33, further comprising providing one or more imaging devices configured to capture the image frames of the environment.

35. A method according to claim 34 further comprising integrating the processor in each of the one or more imaging devices, to process the corresponding consecutive image frames.

36. A method according to claim 34 further comprising implementing the object detection unit in each of the one or more imaging devices to detect the at least one operational vehicle in the corresponding image frames.

37. A method according to claim 34 further comprising implementing a customized operating system in the one or more imaging devices.

38. A method according to claim 34 further comprising:
implementing the control unit external to the one or more imaging devices; and
establishing connection between the control unit and the processor via an MQTT Broker over a TCP connection.

39. A method according to claim 33 further comprising executing an EfficentDet-lite model for the object detection unit.

40. A method according to claim 33 further comprising:
detecting, by the object detection unit, one or more persons in the image frames;
anonymizing, by the object detection unit, the detected one or more persons in the image frames, to generate anonymized image frames;
providing a user interface configured to display the anonymized image frames; and
overlaying, by the user interface, information about the estimated at least one of the speed of the at least one operational vehicle and the trajectory of the at least one operational vehicle on the respective operational vehicle in the displayed anonymized image frames.
